(19) United States
(12) Patent Application Publication
(10) Pub. No.: US 2020/0347558 A1
(43) Pub. Date: Nov. 5, 2020

(54) ARTIFICIAL TURF FIELD APPARATUS AND METHODS

(71) Applicant: FieldTurf, Inc., Montreal (CA)

(72) Inventor: Nicolas Aumonier, Montreal (CA)

(21) Appl. No.: 16/859,838

(22) Filed: Apr. 27, 2020

Related U.S. Application Data
(60) Provisional application No. 62/841,193, filed on Apr. 30, 2019.

(51) Int. Cl. E01C 13/08; B29C 45/26

(52) U.S. Cl. CPC E01C 13/08; B29K 2101/12; B29C 45/2626

(57) ABSTRACT

Apparatus and methods are provided that provide an artificial turf fiber having an integrated fiber and base arrangement. The fibers can be integrally formed with a substrate such by using a molding process. The fibers can be formed to be bonded directly to the base using the molecular bonds of the material that formed the base and fiber at the same time.

### CROSS REFERENCE TO RELATED APPLICATION

This application claims the benefit of U.S. Provisional Application No. 62/841,193, filed on Apr. 30, 2019, the disclosure of which is expressly incorporated herein by reference thereto.

### FIELD OF THE INVENTION

The present invention is related to artificial turf fields.

### BACKGROUND OF THE INVENTION

Artificial turf fields have been in use for many years and have gained special popularity in in athletic playing surfaces. The grass like fibers and supporting infill provide performance and maintenance advantages over natural grass fields, and have a long but limited life. In implementation, artificial turf fields for athletic surfaces must typically meet certain performance characteristics including the specific ability to absorb shock (impact) at a level or range (designated for that field or sport). Conventional techniques for forming artificial turf fields involve extruded fiber that is tufted and glued to backing. These known prior art techniques have various deficiencies and there is a desired to develop new apparatus and method for artificial turf fields.

### SUMMARY

In accordance with embodiments of the present invention, an artificial turf field that provides a playing surface of grass fibers can be provided. The artificial turf field can comprise a substrate made of a thermoplastic polymer, wherein the substrate comprises grass-shaped protrusions integrally formed with the substrate and the grass shaped protrusions are adapted to extend upwardly from the substrate to provide artificial grass fibers for the playing surface of the field. The substrate can be referred to as a base or tile. The artificial turf field can further comprise a plurality of mats that are used to mount the substrate and place the turf on the field. The artificial turf field can have protrusions that are adapted to have circular cross section. Other shapes of cross section are also contemplated such as oval, square, triangular, or star cross section. The artificial turf field can be configured to have the substrate provide the primary support the protrusions. The protrusions can be held in place to the substrate by the molded formation of the protrusions with the substrate. The protrusions can be adapted to be have visual physical properties that are similar to natural grass. The artificial turf field can comprise infill particles that are interspersed between the protrusions.

The substrate and protrusions can be adapted to match predetermined field performance characteristics. If desired, the protrusions are formed to have varying lengths. A plurality of the protrusions can be adapted to have physical properties that cause each protrusion to bend because the protrusion has flexibility that allows the bend based on the weight of the protrusion in relation to the length of the protrusion. The protrusions can be substantially (e.g., meaning at least 85%) all of the grass fibers for the field. The protrusions can be distributed over a surface of the substrate at a density that visually simulates a grass field.

Each protrusion involves a continuous surface transition from a top surface of the substrate to side surfaces of the protrusion.

The protrusions that provide the grass fibers can be adapted to have properties that cause a small percentage of the protrusions to break or break away when subject to use as an athletic surface over eight years.

A method can provided for forming artificial grass fibers, comprising providing a thermoplastic polymer; and integrally forming from the thermoplastic polymer a substrate and grass-shaped protrusions extending from a surface of the substrate. The method can include providing a mold that is shaped to form the substrate and grass-shaped protrusions. The substrate and grass shaped protrusions are made of soft polymers, such as thermoplastic elastomer (TPE), olefin, thermoplastic olefin (TPO), and other similar materials. The method can be used in producing an artificial turf field. Integrally forming can comprise forming a continuous surface traversing a top surface of the substrate to a side of each protrusion. This can include a physical junction formed due to the shape of a mold.

Apparatus and methods are evident to those of skill in the art from the description herein without specifying that it is describing an apparatus, or method.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 is a diagram of perspective view of a plurality of artificial turf panels that are assembled together in accordance with an embodiment of the present invention;

FIG. 2 is a diagram of a side view of a plurality of artificial turf panels in accordance with an embodiment of the invention;

FIG. 3 is a diagram an expanded view of FIG. 2 in accordance with an embodiment of the invention;

FIG. 4 is a diagram of a perspective view of a cross-section of a panel in accordance with an embodiment of the invention;

FIG. 5 is a diagram of a top view of a plurality of panels in accordance with an embodiment of the invention;

FIG. 6 is a diagram of an expanded view of a portion of FIG. 5 in accordance with an embodiment of the present invention;

FIG. 7 is a diagram of an image of a product in accordance with an embodiment of the present invention; and

FIG. 8 is a diagram of an expanded image of a product in accordance with an embodiment of the present invention.

The illustrations are drawn to be illustrative and are not scientific drawings.

### DETAIL DESCRIPTION OF THE INVENTION

In accordance with the principles of the present invention, new artificial turf fields are provided. The current convention in artificial turf fields is that extruded artificial fibers are cut and tufted through a woven backing. The extrusion process involves extruding a material through a die that shapes the cross section of the fiber as it is extruded. Embodiments of the present invention involve forming artificial turf fibers without extruding the fiber but rather using a molding or similar process to form grass fibers that extend from a base. The grass fibers formed by embodiments of the present invention may be referred to as strands. The base and grass fibers are for example formed at the same time. The integrally formed fiber and base can be placed on a support structure such as by being mounted on a mat and placed on a field. This arrangement can be spread over a field to form a new type of artificial turf field. If desired, the fiber can be formed (e.g., molded) separately, connected together with a thin sheet of the same material as the strands. Then this sheet comprising strands can be laid over conventional pads.

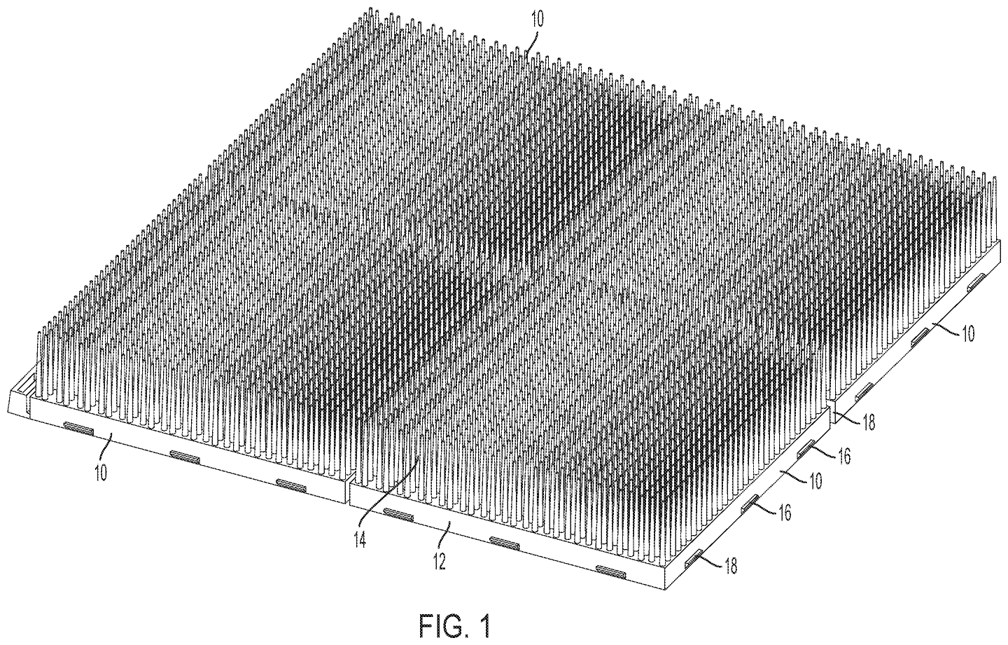

With reference now to FIG. 1, a plurality of panels 10 (as shown four panels) are provided. Panels 10 are arranged to form a playing surface and, in implementation on a field, many panels 10 are arranged in the same fashion to form the playing field. Panel 10 comprises base 12 and artificial grass fibers 14. Base 12 comprises three connectors 16 (e.g., male/female connectors) on each side of each panel 10, which are used to assemble the panels 10. Artificial turf fibers 14 are made from protrusions that extend from the top surface of panel 10. There are many fibers 14 positioned and distributed on each panel 14. Base 12 can comprise a substrate. A particular thickness in relation to the fibers is shown in FIG. 1 but different thicknesses are contemplated. Each base 12 and its grass fibers 14 are integrally formed. For example, a mold is provided that is shaped to form panel 10 including base 12 and protrusions (grass fibers 14). When thermoplastic polymer material is added to the mold, base 12 and fibers 14 are integrally formed.

FIG. 1 is a CAD drawing of panels 10. The panels 10 when produced may have fibers 14 that are leaning or bent, or may appear bent due to the physical properties of the material and the geometric shape of the fibers. An example of this is provided further below. Also as shown, gap 18 is illustrated between each adjacent panel 10. The size of gap 18 can vary. In some embodiments, gap 18 is beneficial for providing water drainage.

Panels 10 may be placed directly on a surface of a field to form the artificial turf field. In some embodiments, a support structure or mat is provided that is used to mount or form a base for panels 10 and the combined arrangement is placed on a surface of a field to form the artificial turf field.

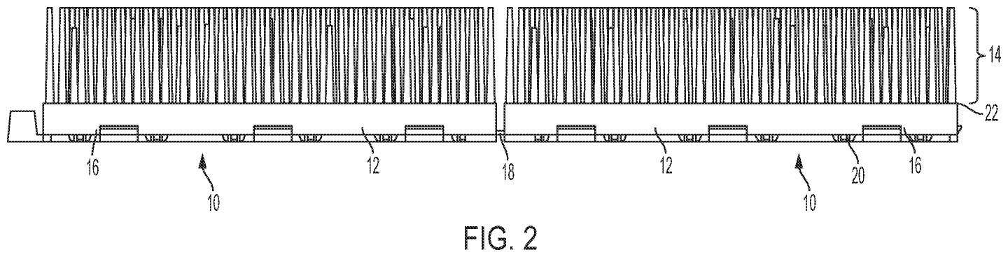

With reference now to FIG. 2, a side view of panels 12 is provided. As shown, fibers 14 have generally uniform height as measured from the top surface 22 of the base 12. In this embodiments, support 20 that is a foot, pin, or bump can be formed as part of base 12. Support 20 touches a support surface such as the field. Support 20 may if desired be part of a mat that holds or supports panel 10. As shown, each fiber 14 can be the same height but this can be varied by design or after the turf is in use due to damage.

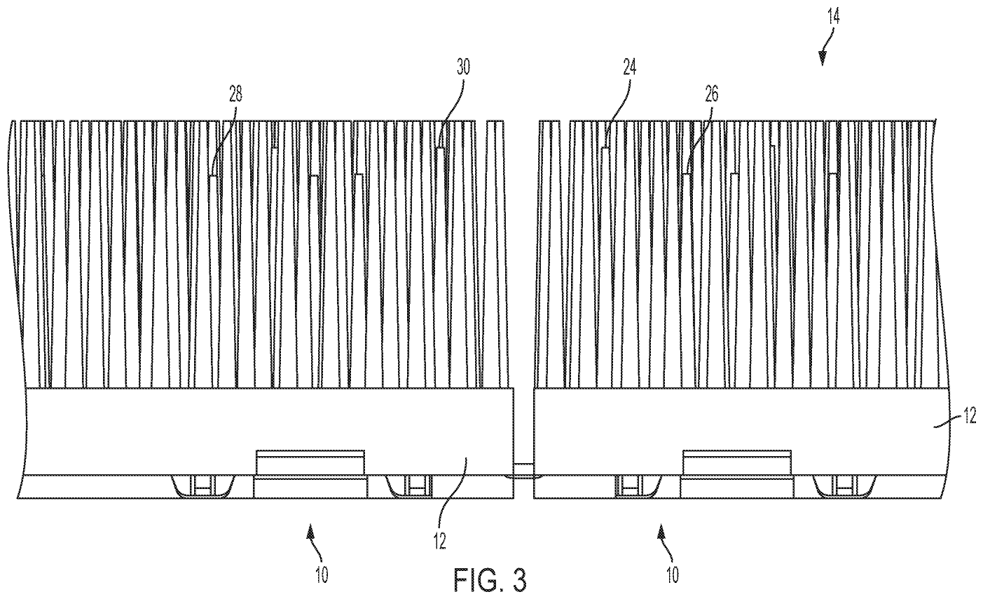

With reference now to FIG. 3, an expanded side view of a portion of FIG. 2 is provided. A portion of two panels 10 are illustrated. As shown in this diagram, fibers 14 can have varying heights 24, 26, 28, and 30. Heights can vary between 4 mm and 60 mm, but more commonly around 25 mm.

As such, fibers 14 when produced for use can have differing heights which can provide a level of visual randomness which can be useful in visually stimulating natural grass. As shown, fibers 14 are formed to have the same general structure. A round protrusion that extends upwards and slowly narrows to a flat tip is illustrated. Other shapes or cross sections are contemplated. The varying heights can be by design either for example by varying the shape of the mold or with the expected estimation that an expected percentage of the fibers ends might not fully exit the mold and a portion may break when the fiber is being removed.

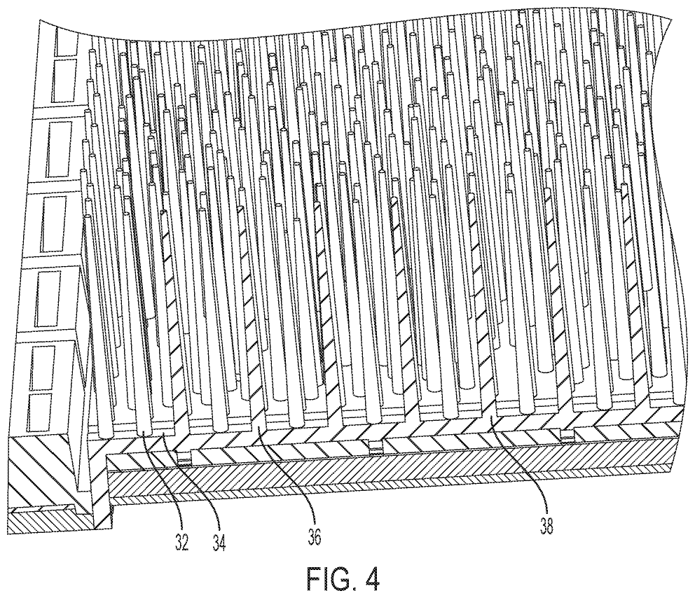

FIG. 4 illustrates a perspective view of a cross section of panel 10. In the illustrated FIGS. 1-3, base 12 and fibers 14 are integrally formed. A line (32) is illustrated at the point at which the grass-like fiber protrude from the surface (34) of the base. This may be formed by for example the shape of mold even though the material is continuous from the base to the sides of the fiber. The integral formation of the fiber and the base (e.g., surface of the base) establishes a continuous surface of material that transitions from the surface of the base to the sides of the fiber. In FIG. 4, a cross section of some fibers (36, 38) are illustrated to demonstrate that the fibers are integral with the base. The lines showing the junction or intersection around the bottom of the fibers is for reference of the physical shape. The junction or intersection is preferably not a junction that may exist if the fiber and base are separately formed and then combined through some form of operation. In some embodiments, a physical line may appear based on the shape or structure of the mold (e.g., by design) while the base and fiber are integrally formed. A continuous and direct bond of the same thermoplastic polymer would exist between the material in the fiber and the base because of the way they were integrally formed together.

The common and the known technique for producing turf fields involving tufting extruded fibers through a woven backing and using an adhesive on the bottom of the backing (glue fiber and backing). In embodiments of the present invention, the fibers are attached to the base or “backing” by way of being integrally formed with a substrate. The application of a glue or adhesive to the back of the backing or bottom surface is not necessary in embodiments of the present invention. The base or substrate supports and holds the fiber in place because of the bond between the thermoplastic material that together formed both the fiber and base together. The base plays also the role of a mat, providing shock absorption properties. The base can have different thicknesses between 1 mm and 25 mm, such as about 12 mm. The base can be formed using one type of polymer and the fibers can be formed using another type of polymer. This allows the capability to choose the appropriate material for the base and fibers, providing adequate mechanical and physical properties.

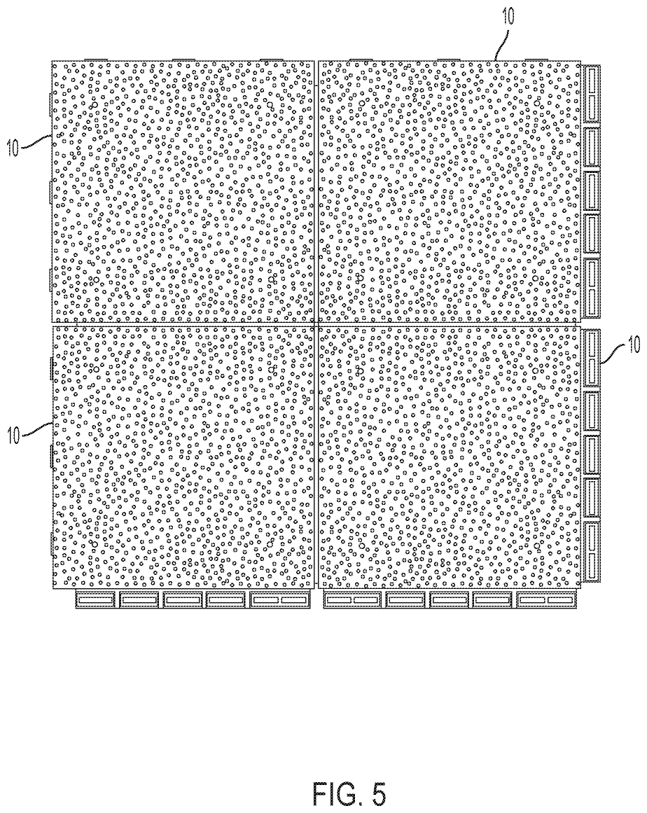

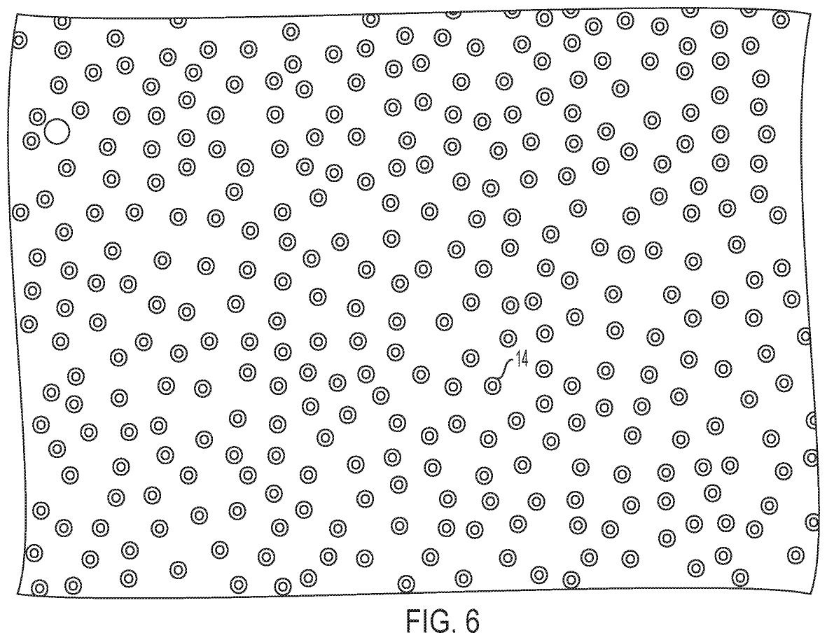

FIG. 5 is an illustrative top of view of a plurality of panels 10 arranged together to form a portion of a field. As shown, many points are provided on the surface of the panels 10 which correspond to fibers 14. FIG. 6 is an expanded view of a portion of FIG. 5. FIG. 6 shows that each fiber 14 from a top view involves an inner circle and an outer circle. Fiber can have a cylindrical, conical, or another shape. As noted, the outer circle corresponds to the transition between the sides of the fiber and the top surface of the base. The fibers are distributed throughout the surface at a density that is sufficient based on the physical characteristics of the fiber and the base (made of the same thermoplastic elastomer, for example, but they can also be made of different types of elastomer or polymer) (and any other part of the turf field) to provide the preplanned physical properties for that field such as providing a desired level shock absorbance (e.g., specific to a particular sport). The number and distribution of fibers can be planned to be sufficient to provide visual similarity to a natural grass field. Random or substantially random positions can be used to mimic a natural field.

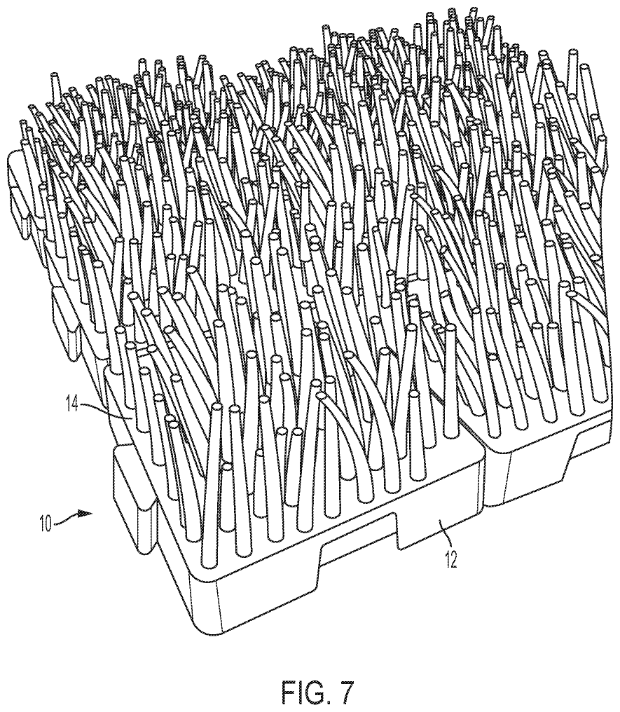

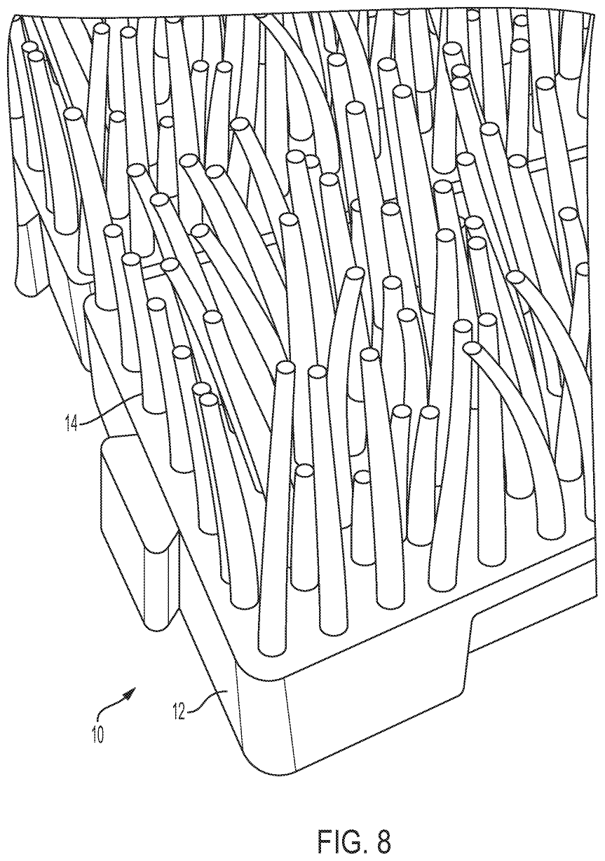

FIG. 7 is a diagram of an image of a test product that was prepared by molding fibers 14 and base 12 together to form panel 10. FIG. 8. is an expanded view of a portion of FIG. 7. As shown, fibers 14 extend from the base and are integral with the base. Fibers 14 have varying heights which can be due to some fibers breaking when they were being removed from the mold, or due to the mold structure itself. The fibers 14 are slightly narrowed as they extend about the base. The formulation of the material and the shape and height of the fibers 14 can be planned to adapt the fiber 14 to be flexible or pliable, or to naturally lien or bend due to the weight of the fiber. They can also be formulated such that they can be groomed in that they can be moved to different positions without springing back to their original position but rather maintaining a groomed position. The fibers can have a level of elasticity preferred for a desired application. Meaning that the fibers can be adapted to have a level of elasticity such that they may spring or revert towards a position when an amount of force is applied (e.g., when a player is running on the field, the fibers are pushed down (potentially compressed), and when forced is removed they revert towards a baseline positions which is not necessarily being upright but rather a drooping on leaning position similar to natural grass).

Those of ordinary skill in the art are familiar with the materials and compositions for forming artificial turf fibers such as by using polypropylene and would be able to make modification or variations based on application or need.

Embodiments of the present invention can be made by creating a mold and injecting thermoplastic elastomer into the mold and allowing the material to harden and take the shape of the mold. A desired thermoplastic polymer is used and pour which when processed results in integrally forming the base (or substrate or mat) and fibers (strands) using the mold. Other techniques can include overmolding, e.g., using an insert such as prefabricated pad that is then overmolded using described technology or molding over an existing piece of structure or a prefabricated pad. The structure can be used in conjunction with a mat or support structure to be placed on a field in order to install a new artificial turf field. The integrally formed structure can involve a continuous surface from the top of the substrate to the sides of the fibers with potential a physical indentation cause by the shape of the mold at the base of the fiber and the top surface.

Examples of the ranges of dimensions for the fibers include the fibers having a height in the range of about 2 mm to 50 mm. The fibers can having varying thickness such as in the range of about 0.5 mm to 15 mm. The rigidity or flexibility of individual fibers (based on the material and physical characteristics) can be in the range of about Shore A 30 to shore A 90, and preferably in the range of about Shore A 40 to Shore A 70. The base or substrate can have a thickness (from bottom to top) in the range of mm to 25 mm.

The techniques for making the above described structures can include molding, overmolding, thermo-forming, or other methods.

Material that can be used for making the fibers and/or base can be elastomeric resins or rubric resins, such as thermoplastic elastomers, thermoplastic polyolefins and ethylene vinyl-acetate, or metallocene type elastomers. The material for making the fibers and/or base is preferably TPO. The grade can be modified by those of ordinary skill in the art in preparing the compound based on application.

In some applications, the fibers and base (or substrate) can be formulated to provide better shock absorbency properties compared to conventional artificial turf field. For example, this may permit, a different type of infill and may require less infill.

Infill particles can include resilient particles such as crumb rubber or other similar material (e.g., crumbled elastomeric material having similar properties). Other particles or types of particles can be in the infill layer such sand, cork, TPE, EPDM, or other material. An infill layer can include two or more layers and can involve different materials mixed to form a single layer.

All dimensions recited herein are approximate and can vary by as much as 10% to in some case 25%. In some situations, the term “about” is used to indicate this tolerance. And when the term “about” is used before reciting a range, it is understood that the term is applicable to each recited value in the range.

Therefore, in sum, it is to be realized that the optimum dimensional relationships for the parts of the invention can include variations and tolerances in size, materials, shape, form, function and use are deemed readily apparent and obvious to the skilled artisan, and all equivalent relationships to those illustrated in the drawings and described in the specification are intended to be encompassed by the claims appended hereto.

Unless defined otherwise, all technical and scientific terms used herein have same meaning as commonly understood by one of ordinary skill in the art to which this invention belongs.

The terms “may” or “can” are used in a similar was as “is” to express that this is one embodiment and others may exist.

The use of “a” or “an” is general understood to mean one or more unless the context or convention understood by one of ordinary skill in the art would be different.

Any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

Exemplary systems, apparatus, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

1. An artificial turf field that provides a playing surface of grass fibers comprising:
a base made of a thermoelastic polymer, wherein the substrate comprises grass-shaped protrusions integrally formed with the substrate and the grass-shaped protrusions are adapted to extend upwardly from the substrate to provide artificial grass fibers for the playing surface of the field.

2. The artificial turf field of claim 1 further comprising a plurality of mats that are used to mount the substrate and place the turf on the field.

3. The artificial turf field of claim 1 wherein the protrusions are adapted to have circular, oval, square, triangular, or star cross section.

4. The artificial turf field of claim 1 wherein the substrate provides the primary support the protrusions.

5. The artificial turf field of claim 1 wherein the protrusions are held in place to the substrate by molded formation of the protrusions with the substrate.

6. The artificial turf field of claim 1 wherein the protrusions are adapted to be have visual physical properties that are similar to natural grass.

7. The artificial turf field of claim 1 further comprising infill particles that are interspersed between the protrusions.

8. The artificial turf field of claim 1 wherein the substrate and protrusions are adapted to match predetermined field performance characteristics.

9. The artificial turf field of claim 1 wherein the protrusions are formed to have varying lengths.

10. The artificial turf field of claim 1 wherein a plurality of the protrusions are adapted to have physical properties that causes each protrusion to bend because the protrusion has flexibility that allows the bend based on the weight of the protrusion in relation to the length of the protrusion.

11. The artificial turf field of claim 1 wherein the protrusions provide substantially all of the grass fibers for the field.

12. The artificial turf field of claim 1 wherein the protrusions are distributed over a surface of the substrate at a density that visually simulates a grass field.

13. The artificial turf field of claim 1 wherein for each protrusion, a continuous surface transitions from a top surface of the substrate to side surfaces of the protrusion.

14. The artificial turf field of claim 1 wherein the protrusions are adapted to have properties that causes a small percentage of the protrusions to break or break away when subject to use as an athletic surface over eight years.

15. A method for forming artificial grass fibers, comprising:
providing a thermoplastic polymer; and
integrally forming from the thermoplastic polymer a substrate and grass-shaped protrusions extending from a surface of the substrate.

16. The method of claim 15 comprising providing a mold that is shaped to form the substrate and grass-shaped protrusions.

17. The method of claim 15 wherein the integrally forming comprises molding the thermoplastic polymer.

18. The method of claim 15 further comprising providing an artificial turf field comprising performing method claim 15 and further comprising providing a support structure to place the integrally formed substrate and protrusions on a field.

19. The method of claim 15 wherein the integrally forming comprises forming a continuous surface traversing a top surface of the substrate to a side of each protrusion.
